(19) United States
(12) Patent Application Publication
(10) Pub. No.: US 2012/0003547 A1
(43) Pub. Date: Jan. 5, 2012

(54) Electrode Material, Lithium-Ion Battery And Related Methods

(76) Inventor: Rishi Raj, Boulder, CO (US)

(21) Appl. No.: 13/174,732

(22) Filed: Jun. 30, 2011

Related U.S. Application Data
(60) Provisional application No. 61/360,464, filed on Jun. 30, 2010.

(51) Int. Cl. H01M 10/0562; F27D 19/00; H01M 4/1391; H01M 4/62; H01M 4/131

(52) U.S. Cl. 429/322; 429/232; 429/207; 429/218.1; 429/231.8; 429/218.2; 29/623.1; 432/18; 29/623.5

(57) ABSTRACT

An electrode comprising a cast-film architecture wherein a silicon-based polymer precursor is cast on to a current collector directly from the liquid, and processed in-situ to create a high performance anode for lithium ion batteries. In this in-situ process the liquid polymer is cross-linked and pyrolyzed to create a cast-film-anode architecture. The cast-film architecture is distinctly different from the conventional powder-based ex-situ process whereby the polymer precursor is made into powders by a ex-situ process; with these powders being then combined with conducting agents and binders to create a paste which is screen printed on a current collector to produce electrode with a powder-anode architecture. The cast-film architecture obviates the need for conducting agents and binders, simplifying the production process for the anode, without a loss in performance. The energy capacity per unit volume of the anode material is two to ten times greater for the cast architecture.

### RELATED APPLICATIONS

This application claims the benefit of priority to U.S. Application Ser. No. 61/360,464 filed Jun. 30, 2010, the entire contents of which is incorporated herein by reference.

### BACKGROUND

As a rechargeable battery, a lithium-ion battery includes lithium ions in a liquid electrolyte that move back and forth between the anode and the cathode. The lithium ions move from the anode to the cathode when the battery passes an electric current through an external circuit (i.e. discharging), and move from the cathode to the anode when charging. The cathode material of a lithium-ion battery may be, for example, titanium disulfide, a layered oxide such as lithium cobalt oxide, a polyanion-based material such as lithium iron phosphate, or a spinel such as lithium manganese oxide. The liquid electrolytes in Li-ion batteries typically comprise lithium salts, for example, LiPF₆, LiBF₄, or LiClO₄, in an organic solvent such as ether.

Despite the development of various anode materials, these materials exhibit less than satisfactory properties or performances, or they exhibit a poor balance between different properties and performances. For example, the material most commonly used for an anode in Li-ion batteries is based upon derivatives of graphite, which is known to have a theoretical capacity of 372 mAhg⁻¹. Edward Buiel et al. disclosed hard carbon as an anode material in J. Electrochem. Soc., Vol. 145, No. 6, June 1998. However, the hard carbon's irreversible capacity (511 mAhg⁻¹) and reversible capacity (220 mAhg⁻¹) are both low. In a paper published by Masaki Yoshio et al. in J. Mater. Chem., Vol. 14, 1754-1758, 2004, sphere graphite was used as the electrode material, but its irreversible capacity and reversible capacity are only 402 mAhg⁻¹ and 364 mAhg⁻¹ respectively. H. Fugimoto et al. have explored the use of meso carbon micro beads (MCMB) in J. Power Sources, Vol. 54, 440-443, 1995, however, the irreversible capacity and reversible capacity of MCMB remain as low as 531 mAhg⁻¹ and 325 mAhg⁻¹. Milled mesophase pitch-based carbon fibers (mMPCFs) show an irreversible capacity of 760 mAhg⁻¹ and a reversible capacity of 350 mAhg⁻¹ in M. Endo et al, Carbon, Vol. 37, 561-568, 1999. Tin (Sn) demonstrates a higher irreversible capacity (1250 mAhg⁻¹) and reversible capacity (1000 mAhg⁻¹), but its cyclic stability is poor, as taught in J. Hassoun et al., Israel Journal of Chemistry, Vol. 48, 2008. The cyclic stability of tin-based oxide (SnO₂) is also poor, although the material has an irreversible capacity of 2013 mAhg⁻¹ and a reversible capacity of 1500 mAhg⁻¹ (P. Meduri et al., Nano Letter, Vol. 9(2), 2009). As known to a skilled person in the art, the cyclic stability is measured as the loss in energy density with the number of charge-discharge cycles. The term “discharge rate” is an indication of the rate at which the anode can be discharged, which can be expressed as:

XC, where

X is equal to the inverse of the discharge time in units of hours.

For example, X=0.1 implies a discharge time of 10 h, and X=10 a discharge time of 6 min. The power-density of an anode is given by the product of the energy density and the discharge rate. Lithium titanate exhibits a capacity retention of 85%@10C, but its irreversible capacity and reversible capacity are extremely low, being 165 mAhg⁻¹ and 160 mAhg⁻¹ respectively (K. Nakahara et al., J. of Power Sources, Vol. 17, 2003).

Si-based materials have also been used as the anode material for a lithium-ion battery. For example, Si-based polymers exhibit an irreversible capacity of 1100 mAhg⁻¹ and a reversible capacity of 800 mAhg⁻¹, as disclosed in W. Xing et al., Solid State Ionics, Vol. 93, 239-244 (1997); A. M. Wilson, Solid State Ionics, Vol. 100, 259-266 (1997); W. Xing et al., J. Electrochem. Soc., Vol. 144(7), 2410-2416 (1997); Riedel et al., J. European Ceram. Soc., Vol. 26(16), 3897-3901 (2006); Riedel et al., J. European Ceram. Soc., Vol. 26(16), 3903-3908 (2006); U.S. Pat. Nos. 5,631,106; 5,824,280; 5,907,899; and 6,306,541. Thin film electrodes using a silicon film can demonstrate an irreversible capacity of up to 4277 mAhg⁻¹ and a reversible capacity of up to 3124 mAhg⁻¹, according to C. Chan et al., Nature Nanotechnology, December 2007; and thin film electrodes using a Si—Al film can have an irreversible capacity of up to 4277 mAhg⁻¹, a reversible capacity of up to 3124 mAhg⁻¹, and a C-rate of 5 C @ 50% capacity retention, according to L. B. Chen et al., Electrochimica Acta, Vol 53, 2008. Nevertheless, while Si has a very high capacity, it does not perform well in other areas.

Recently, composites made from graphene nanosheets (GNS) combined with various particulates have been studied as anode materials. The particulates including carbon C60 and carbon nanotubes (Yoo et al., Nano Lett., Vol. 8(8), 2277-2282 2008), tin-oxide (Paek et al., Nano Lett., Vol. 9(1), 72-75 2009) and titanate powders (Watanabe et al., Abstract, 214^{th} ECS Conference, 2008) have been reported as anode materials. These materials possess discharge capacities of up to 1000 mAhg⁻¹, but the capacity degrades rapidly with the number of cycles.

A common method for anode preparation involves mixing powders of active materials, such as materials cited in the preceding paragraphs (e.g., graphite derived materials, silicon-based materials, lithium titantate) with a binder and, if needed, a powder of a conducting agent and depositing the resulting paste onto a sheet-metal current collector, made from materials such as copper or stainless steel, as a thin layer. This form of anode architecture is referred to as Powder-Anode architecture

### SUMMARY

In an embodiment, an electrode-architecture includes a monolithic anode disposed upon at least a portion of a surface of a current collector. Monolithic anode implies that the liquid form of the polymer precursor of the anode material is deposited directly on to the surface of the current collector, and is then processed in-situ into the final anode material. The form and geometry, and the process used to prepare this Cast-Film Anode architecture is distinct from the conventional Powder-Anode architecture.

In an embodiment, a method of preparing a monolithic electrode-architecture includes: (i) collector; (ii) masking the current collector; (iii) applying an anode material comprising a graphene oxide and a liquid polymer to at least a portion of a surface of the current collector, (iii) crosslinking the anode material; (iv) pyrolyzing the crosslinked anode material in an inert atmosphere at temperatures of up to 1100° C.; (v) removing the mask to reveal channels; and (vi) applying a conducting agent and an electrolyte to the channels.

In an embodiment, a method of preparing a Cast-Film Anode architecture includes: (i) providing a current collector; (ii) applying an anode material comprising a graphene oxide and a liquid polymer to at least a portion of a surface of the current collector; (iii) pyrolyzing the anode material in an inert atmosphere at temperatures of up to 1100° C. to affect spontaneous cracking; and (iv) applying a conducting agent and an electrolyte to the cracked anode material.

### BRIEF DESCRIPTION OF THE DRAWINGS

FIG. 1 schematically shows the nanocomposite structure of an anode including graphene oxide sheets distributed in a polymer-derived matrix, according to an embodiment;

FIG. 2 is the plot of the cyclic stability in terms of specific capacity (mAh/g) and the coulombic efficiency (%) of anodes tested under a 0.01V˜3.0V voltage-window, according to an embodiment;

FIG. 3 shows the measured discharge rate capability of anodes after charging at 100 mA/g current density with 0.01-3.0V voltage-window as the C-rate was increased from 0.2 C (or C/5) to 22 C, according to an embodiment;

FIG. 4a shows the capacity retentions of anodes as compared with a control under 0.01˜2.5V voltage-window as a function of C-rate in a range up to 1000 C, according to an embodiment;

FIG. 4b shows the capacity retentions of anodes as compared with a control under 0.01˜2.5V voltage-window as a function of C-rate in a range up to 100 C, according to an embodiment;

FIG. 5 shows the discharge capacities of anodes under different current density states with 0.01˜2.5V voltage-window, according to an embodiment;

FIG. 6 shows the power density of anodes as a function of C-rate with 0.01˜2.5V voltage-window, according to an embodiment;

FIG. 7 shows a conventional anode architecture, according to the prior art;

FIG. 8 shows an exemplary Cast-Film Anode architecture, according to an embodiment; and

FIG. 9 shows a top plan view of a Cast-Film Anode containing channels created by masking and filled with conducting agent and electrolyte, according to an embodiment.

### DETAILED DESCRIPTION

As used herein, a monolithic structure, such as monolithic electrode-architecture or monolithic anode, is one where anode material involves a film deposited directly onto a current collector. In one embodiment, the film thickness ranges from 0.1 micrometer to 1000 micrometers. This architecture is prepared by an in-situ process, which offers clearly distinguishable characteristics compared to the conventional ex-situ process. In the conventional ex-situ process, the polymer-precursor for the active anode material is cross-linked ex-situ, pulverized into powder, converted into a ceramic powder, and combined with a conducting agent and a binder into a paste which is deposited onto the current collector by a doctor-blade process. In the in-situ process, the polymer-precursor for the active anode material is deposited directly onto the current collector as a liquid film, which is cross-linked and pyrolyzed in-situ into the cast-film of the active anode material, obviating the need for a binder or a conducting agent. In the architecture resulting from the in-situ process (in-situ cast-film architecture), the anode material is in continuous contact with the current collector over an area of at least 10 micrometers by 10 micrometers, and electrons are transported from the anode material to the current collector by direct and continuous contact. In the architecture resulting from the ex-situ process, (ex-situ architecture), the powder particles of the active anode material transport electrons to the current collector via a conducting agent that is mixed in with the anode powder into a paste and deposited onto the anode. As used herein, the novel in-situ cast-film architecture is called Cast-Film-Anode, whereas the ex-situ conventionally processed powder anode is called Powder-Anode.

The term “C rate” is an indication of the rate at which an anode can be discharged, which can be expressed as
XC, where
X is equal to the inverse of the discharge time in units of hours, such as amp hours.
For example, X=0.1 implies a discharge time of 10 hours, X=10 a discharge time of 6 min, and C/20=0.05 C implies a discharge time of 20 hours.

The present instrumentalities describe electrode materials, lithium-ion (Li-ion) batteries using the same, and methods of preparing the same. Such materials, batteries, and methods have particular application in conjunction with electric cars, hybrid electromotive cars, mobile phones, and personal computers, among other devices; and will be described with particular reference thereto. However, it is to be appreciated that the present exemplary embodiments are also amenable to other applications.

Advantageously, the present instrumentalities provide anode materials such as nanocomposites made from graphene oxide (GO), carbon nanotubes, and silicon-based polymers, Li-ion batteries using the same, and methods of preparing the same. The present methods are safer and environmentally friendlier processes than existing methods for producing Li-ion batteries, and the present anode materials exhibit numerous technical merits. For example, the anode materials exhibit high energy densities, such as ˜800 mAhg⁻¹, reversible capacity, superlative power densities that exceed 250 kW/kg, high stability, and resistance to failure.

In various embodiments, the present electrode materials, particularly anode materials for Li-ion batteries, comprise a nanocomposite of graphene oxide, carbon nanotubes and a silicon-based polymer matrix. In the electrode material, the graphene oxide, or carbon nanotubes, may comprise from about 0.0% to about 50.00% by weight and the silicon-based polymer from about 100% to about 50.00% by weight based on the total weight of the precursor for the Cast-Film-Anode process.

In preferred embodiments, the silicon-based polymer is a pyrolyzed silicon-based polymer. The silicon-based polymer may comprise silicon and at least three elements selected from oxygen, nitrogen, carbon and hydrogen. For example, the silicon-based polymer may have a general formula of

SiCₓN_{y}O_{z}Hₘ, where

x=0.7-2, y=0-0.8, z=0-0.85, and m=0-5.

The active-electrode starting materials, such as polymer precursors, may also be combined with any other suitable components, for example, carbon nanotubes and graphene-oxide, and surfactants. As used herein, polymer precursors are responsible for the materials that store lithium. In exemplary embodiments, the other suitable components range from 0% to about 50% of the total weight of the material used for casting the film on the current collector in the Cast-Film Anode architecture.

In a specific embodiment, the material for casting the anode contains about 1% to 30% of the other components comprising graphene-oxide, carbon nanotubes and surfactants, in various combinations. This range may be alternatively from 5% to 30%.

Lithium-ion batteries may include anodes having the electrode materials described above. The anodes for the lithium-ion batteries are constructed from nanocomposites of graphene oxide, carbon nanotubes, and polymer hybrids. For simplicity, the nanocomposite-anodes made from graphene oxide (GO) and the silicon-based polymers are called graphene oxide nanocomposite anodes, or GO-NC-anodes. The GO-NC-anode may exhibit numerous superior performances relative to traditional anodes including: (1) a capacity of about 800 mAhg⁻¹ when the lithium-ion battery cycles at a C rate of C/20 for at least 500 cycles, wherein the term “C rate” is an indication of the rate at which the anode can be discharged, which can be expressed as

XC, where

X is equal to the inverse of the discharge time in units of hours.

For example, X=0.1 implies a discharge time of 10 hours, X=10 a discharge time of 6 min, and C/20=0.05 C implies a discharge time of 20 hours; (2) a capacity retention of at least 100 mAhg⁻¹ when the lithium-ion battery cycles at C rate of 100 C for at least 500 cycles; (3) a capacity retention of at least 85% after the lithium-ion battery runs for 1000 cycles under a 0.01V˜3.0V voltage-window at C/5 rate; (4) a capacity retention of at least 90% after the lithium-ion battery runs for 1000 cycles under a 0.01 V˜3.0V voltage-window at C/10 rate; (5) a power density of at least 250 kW/kg after the lithium-ion battery runs for at least 100 cycles under a 0.01-2.5 V voltage-window at a rate of 6000 C; and (6) a recovery of at least 95% charge capacity after the lithium-ion battery runs for at least 500 cycles under a 0.01-2.5 V voltage-window at a rate of 2000 C.

A process for preparing a Cast-Film-Anode, includes:

(i) providing a liquid polymeric precursor such as siloxanes and/or silanes, for example, 1,3,5,7-tetramethyl-1,3,5,7-tetravinylcyclotetrasiloxane (TTCS);

(ii) providing graphene oxide, carbon nanotubes or combinations thereof;

(iii) mixing the liquid polymeric precursor and at least one component selected from graphene oxide and carbon nanotubes;

(iv) casting the liquid mixture onto a current collector surface as a film, having a thickness ranging from 0.1 micrometer to 1000 micrometers;

(iv) crosslinking such as thermally crosslinking the film; and

(v) pyrolyzing the film in an inert atmosphere at temperatures of up to 1100° C.

In preferred embodiments, the method further comprises in situ reduction of the graphene oxide into a functionalized form of graphene. For example, the reducing agent may be the pyrolysis products, such as hydrocarbons and hydrogen.

In an embodiment, 1,3,5,7-tetramethyl-1,3,5,7-tetravinylcyclotetrasiloxane (TTCS) was mixed with graphene to prepare the nanocomposite. The product exhibited a reversible energy density of 800 mAhg⁻¹ a cyclic stability to within 95% of the initial value after 100 cycles, and a discharge rate capacity of up to 25 C, when the anode was prepared by the Powder-Anode process.

A process for preparing a Powder-Anode, includes:

(i) providing a solid polymer;

(ii) milling the solid polymer with graphene oxide; and

(iii) pyrolyzing the milled mixture in an inert atmosphere at temperatures of up to 1100° C.;

(iv) combining the pyrolyzed powder with a binder and a conducting agent to form a paste; and

(v) screen printing the paste onto a current collector.

In preferred embodiments, reduction of the graphene oxide is achieved in situ during the pyrolysis.

Without being bound by theory, it is believed that the superior performance demonstrated by the present anode materials is at least partially because the graphene-polymer nanocomposite is prepared by reducing oxidized graphene in situ. As known to a skilled artisan, exfoliated graphene structures are primarily available in an oxidized state. Oxidation helps to exfoliate the lamellar structure of graphite. However, the oxidation results in making the graphene structure non-conductive. For an effective anode structure, it is vital that this graphene phase be conducting. To that end, the graphene structure is usually reduced using hydrazine hydrate, which is however a toxic chemical with high affinity to oxygen rendering it an explosion and fire hazard. The present anode materials differ in two aspects. First, a hybrid comprising an oxidized graphene structure is dispersed evenly in a silicon-based polymeric precursor such as siloxanes, silanes, or others. Upon heating these polymers to a high temperature such as a range of 600-800° C., the material tends to evolve hydrocarbons and hydrogen. This creates a reducing environment that removes oxygen from the oxidized graphene and makes it conductive. Secondly, when the oxidized graphene is reduced, it tends to de-exfoliate, i.e., graphene layers start coming close to each other and make small graphitic phases. However, the presence of silicon-based polymer around the graphene sheets prevents the sheets from clustering together. This allows the reduced, conducting graphene phase to form a stable hybrid structure. The interface between the graphene and the polymer tends to act as the reaction site for Li-ions to transfer charge within the anode. Since this interface is created at nanoscale, it provides high specific area for reaction and thereby results in anode with extremely high specific charge capacity.

For example, exfoliated graphene and silicon-based polymer precursor are dispersed in a solvent such as acetone with or without surfactant such as Triton 100×. The dispersed solution is deposited as a liquid film onto the current collector; this liquid film is crosslinked in-situ in various ways: thermally, catalytically or under electromagnetic radiation such as light, gamma rays, neutron beams, and others. This results in the liquid polymer transforming into a film of an epoxy-like solid. In one embodiment, the cross-linked film is pyrolyzed, in-situ, by heat treatment in the temperature range from about 600° C. to 1000° C. In another embodiment, 800° C. heat treatment worked well and provided an optimum amount of hydrogen in the silicon structure to produce a hybrid with excellent charge storage and fast charging and discharging cycle capability, as disclosed in G. D. Soraru, L. Pederiva, J. Latournerie and R. Raj, J. Am. Ceram. Soc., Vol. 85(9), 2181-7 (2004), which is incorporated herein by reference in its entirety. Also, at 800° C., enough hydrogen and hydrocarbons evolve from the polymer to reduce the oxidized graphene substantially to completion.

In the conventional Powder-Anode architecture, such as that shown in FIG. 7, an active anode material 70, a conducting agent 72, and a binder and/or electrolyte 74 are mixed and applied with a certain thickness, h, to a current collector 76, which is usually a metal sheet material, which serves as a current collector carrying electrons to the external circuit.

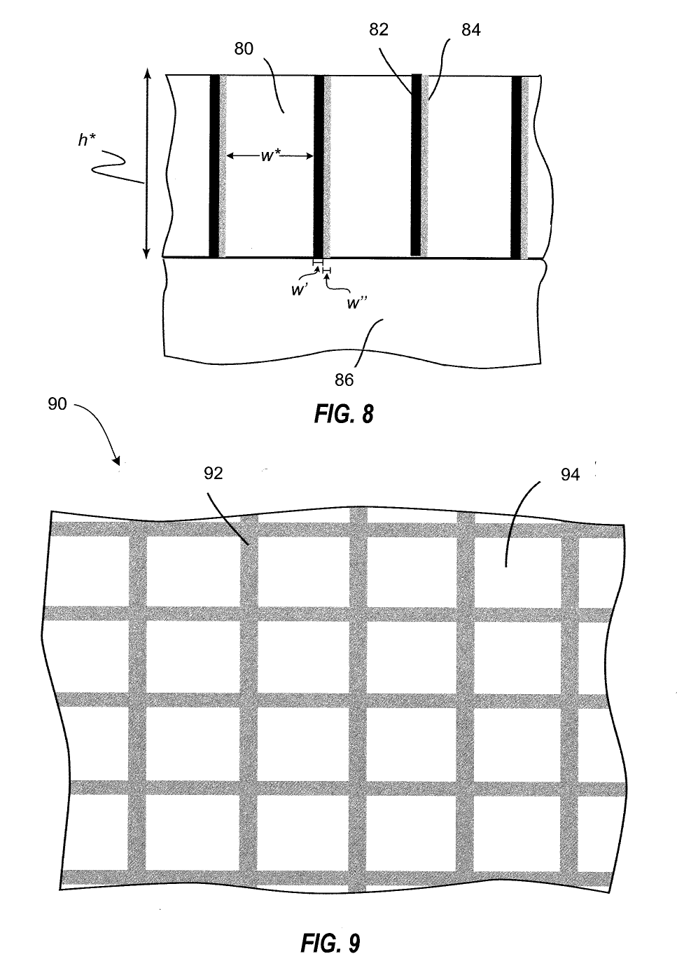

GO-NC-anodes having the Cast-Film-Anode architecture, such as those shown in FIGS. 8 and 9, provide improved performance. As shown in FIG. 8, the GO-NC anode material 80 is disposed as one or more monoliths, and the conducting agent 82 and the electrolyte 84 form one or more channels connecting current collector 86 to the surface of the anode 80. Typically, the thickness, h*, of anode material 80, conducting agent 82, and electrolyte 84 is between 0.1 micrometer and 1000 micrometer. The width, w*, of anode material 80 may be between 1.0 micrometer and 1.0 centimeter, the width, w′, of conducting agent 82 may be between 0.01 micrometer and 1 micrometer, and the width, w″, of the electrolyte 84 may be between 0.1 micrometer and 10 micrometer.

Graphene flakes introduced into monolithic anode 80 by the graphene oxide process may serve as conducting agent 82.

Bonding between cast-film anode 80 and current collector 86 may be achieved by a “bond coat”, made from silicon carbonitride, having a thickness of 0.001 μm to 1 μm, deposited between the monolithic anode and the current collector. Deposition may be affected, for example, using a liquid spray method as described by S. R. Shah and R. Raj, “Multilayer Design and Evaluation of a High Temperature Environmental Coating” J. Am. Ceram. Soc., Vol. 90[2], 516-522 (2007).

FIG. 9 shows a top plan view of a Cast-Film-Anode 90 containing channels 92 created by masking. Areas that are not covered with a mask during application of an anode material 94 onto a current collector (not shown) are physically raised relative to channels 92, which may be filled with conducting agent and electrolyte to create the structure shown in cross-section in FIG. 8. Generally, masking assures a uniform distribution or pattern of channels 92.

In an alternate embodiment, channels 92 may be achieved by spontaneous cracks that form in monolithic anode 80 when the crosslinked polymer is pyrolyzed into the ceramic state because of shrinkage accompanying the pyrolysis process. It will be understood that channels 92 that form as spontaneous cracks may not be uniformly distributed and neighboring channels might intersect.

In an embodiment, a current collector of a conventional Powder-Anode architecture or a Cast-Film-Anode architecture may be a metal foil having a thickness between about 5 micrometers and 500 micrometers. The metal is selected so that it does not react with lithium. Suitable metals for use as current collectors in Li-ion batteries include copper and stainless steel.

The volumetric energy density of an anode is given by the maximum quantity of lithium charge, expressed in equivalent mAh (milliampere hours) that can be stored in the anode, per unit volume of the monolithic layer. The volumetric energy density can also be expressed as mAh cm⁻², by specifying the thickness of the monolithic layer deposited on the current collector.

The ratio of the volumetric energy density in the Cast-Film-Anode and the volumetric energy density in the conventional Powder-Anode architecture is given by:

$${F}_{v} = \frac{VolumetricDensityCastFilmAnode}{VolumetricDensityPowderAnode} = \frac{{v}^{*}}{v} \qquad ( Eq . 1 )$$

where,

Fᵥ is the advantage ratio, the FIG. of merit for the monolithic architecture; and,

v* is the volume fraction of the anode material in the Cast-Film-Anode architecture; and

v is the volume fraction of the anode material in the Powder-Anode architecture. Since the range of values achievable for v*≧0.9, while the range of values for the powder anode are v=0.10-0.2, the advantage ratio can vary from Fᵥ=500% to 1000%.

Another way of measuring the FIG. of merit for the volumetric energy density in the anode is to specify the energy density per unit surface area of the anode, in units of mAhcm⁻². In this instance the advantage ratio, F_{A}, is given by:

$${F}_{A} = \frac{{mAhcm}^{- 2} CastFilmAnode}{{mAhcm}^{- 2} PowerAnode} = \frac{{v}^{*}}{v} \cdot \frac{{h}^{*}}{h} \qquad ( Eq . 2 )$$

where,

v* is the volume fraction of the anode material in the Cast-Film-Anode architecture; and

v is the volume fraction of the anode material in the Powder-Anode architecture; and,

h* is the thickness of the Cast-Film-Anode; and,

h is the thickness of the conventional Powder-Anode.

Note that Fᵥ=F_{A}, if h*=h.

In some instances, a thin-film Cast-Film-Anode may be desired in order to achieve fast charge and discharge from the battery, that is, to achieve high power density. In this case, the monolithic anode can deliver much higher power density at a given energy density. When Eq. 2 is rewritten for the condition that F_{A}=1, i.e., the same value of the energy density, it becomes:

$$\frac{{h}^{*}}{h} = \frac{v}{{v}^{*}} . \qquad ( Eq . 3 )$$

where,

v* is the volume fraction of the anode material in the Cast-Film-Anode architecture; and

v is the volume fraction of the anode material in the Powder-Anode architecture; and,

h* is the thickness of the Cast-Film-Anode; and,

h is the thickness of the conventional Powder-Anode.

Therefore the thickness of the electrode for the Cast-Film-Anode, which has the same energy density as the conventional Powder-Anode, can be equal to one sixth to one third the thickness of the coating in the conventional Powder-Anode.

### Example 1

### Preparation of Electrode Material for the Conventional Powder-Anode Architecture

Two different processing routes were used to synthesize the anode material in Examples 1 and 2. In Example 1 graphene oxide was mixed into the liquid precursor, followed by cross-linking into a hard epoxy, pulverizing the epoxy into a fine powder, followed by pyrolysis in the 600° C. to 1000° C. range. In Example 2 the liquid precursor was first cross linked by itself and graphene-oxide was added to the is epoxy during the attrition milling, after which the co-milled powder was pyrolyzed in the 600° C. to 1000° C. range. In both processes, the graphene oxide was fabricated by a method disclosed in W. Hummers, J. Am. Chem. Soc., Vol. 80(6), (1958), which is incorporated herein by reference in its entirety.

### Example 2

### Preparation of the Powder-Anode Architecture-I

Graphene oxide was mixed with a liquid phase TTCS and a peroxide catalyst such as dicumyl peroxide, in a weight ratio of graphene oxide:precursor:catalyst=5˜50:95˜50:1˜5. The mixture was then kept in an ultrasonic bath followed by high speed shear homogenizer to produce good dispersion. After the dispersion process, the liquid suspension was crosslinked in an argon purged vertical tube furnace for about 1 to 5 hours at a temperature from 200° C. to 400° C. Then, it was pyrolyzed at a higher temperature in the argon purged furnace for about 3 hours to 10 hours. The pyrolysis temperature range was from about 700° C. to 1000° C.

### Example 3

### Preparation of the Powder-Anode electrode Architecture-II

Graphene oxide was mixed with a crosslinked polymer powder, which was made from TTCS and peroxide catalyst such as dicumyl peroxide in a weight ratio of graphene oxide:crosslinked polymer powder of from about 5:95 to about 50:50. Crosslinking of the polymer was performed in an argon purged vertical tube furnace from 200° C. to 400° C.

Then the mixture was ground in an attrition mill for about 5 to 20 hours with a liquid medium such as acetone or methyl alcohol to dissipate heat and avoid burning. The attrition milling was performed using zirconia balls. Subsequently, the milled powder in the liquid medium was dried in a convection oven for about 1 to 10 hours followed by pyrolysis at an elevated temperature in an argon purged furnace for about 3 to 10 hours. The pyrolysis temperature range was from about 700° C. to 1000° C.

### Example 4

### Electrode and Half Cell

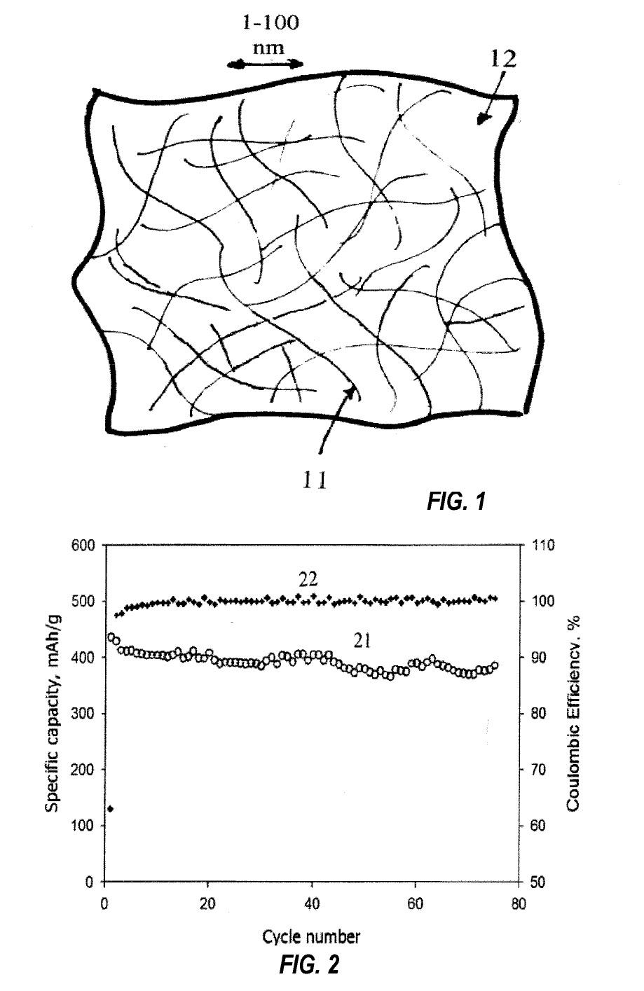

The Powder-Anodes were prepared from the milled and pyrolyzed powder using two methods. Some anodes were prepared using mixtures comprising by weight 80% of the powder of the active material, 10% acetylene black, and 10% polyvinylidene fluoride (PVDF) as a slurry in 1-methyl-2-pyrrolidinone. Some anodes were prepared using mixtures comprising by weight 90% active material and 10% PVDF as a slurry in 1-methyl-2-pyrrolidinone. Then the mixtures were spread onto copper foil using the screen printing method with a 125 micrometer applicator. As will be evidenced in Examples 5-9, both methods produced similar properties in the anodes. Without the intention to be bound by any particular theory, it is envisioned that both methods produced a nanocomposite structure of anodes as schematically shown in FIG. 1. With reference to FIG. 1, graphene oxide sheets 11 are distributed in a polymer-derived matrix 12 made from SiCₓN_{y}O_{z}Hₘ, where x=0.7-2, y=0-0.8, z=0-0.85, and m=0-5.

A half-cell was constructed in layers with a pure lithium foil at bottom, a polymer separator and the anode material on top. For testing, LiPF₆ in ethylene carbonate and dimethyl carbonate was used as the battery electrolyte. Specifically, a half cell was constructed with the prepared electrode serving as the working electrode in a 2324-type coin cell, and lithium foil disks were used as the counter and reference electrodes. A polymer membrane which was composed of polypropylene and polyethylene and 1 M LiPF₆ in a mixed solution of ethylene carbonate and diethyl carbonate (volume ratio 1:1) were used as the separator and the electrolyte, respectively. The coin-cells were assembled, crimped and closed in an argon-filled glovebox and tested with a rechargeable battery (BT 2000, Arbin Instrument) following a usual procedure. The performances of the anodes were measured and described in Examples 4-9 and FIGS. 2-6.

### Example 5

### Cyclic Stability and Coulombic Efficiency

FIG. 2 is a plot of the cyclic stability in terms of specific capacity (mAh/g) and the coulombic efficiency (%) of Powder-Anodes tested under a 0.01 V˜3.0V voltage-window. With reference to FIG. 2, data points 21 are the specific capacities as a function of the cycle number, and data points 22 are the coulombic efficiencies as a function of the cycle number. As graphite is known to have a theoretical capacity of 372 mAhg⁻¹, FIG. 2 demonstrates that the Powder-Anodes have a better stability of the energy density for up to 75 cycles, measured as a C-rate of 0.2 C. FIG. 2 also demonstrates that the coulombic efficiency, which is the ratio of the charge to discharge capacity, remains near 100% after 75 cycles.

### Example 6

### Discharge Rate Capability

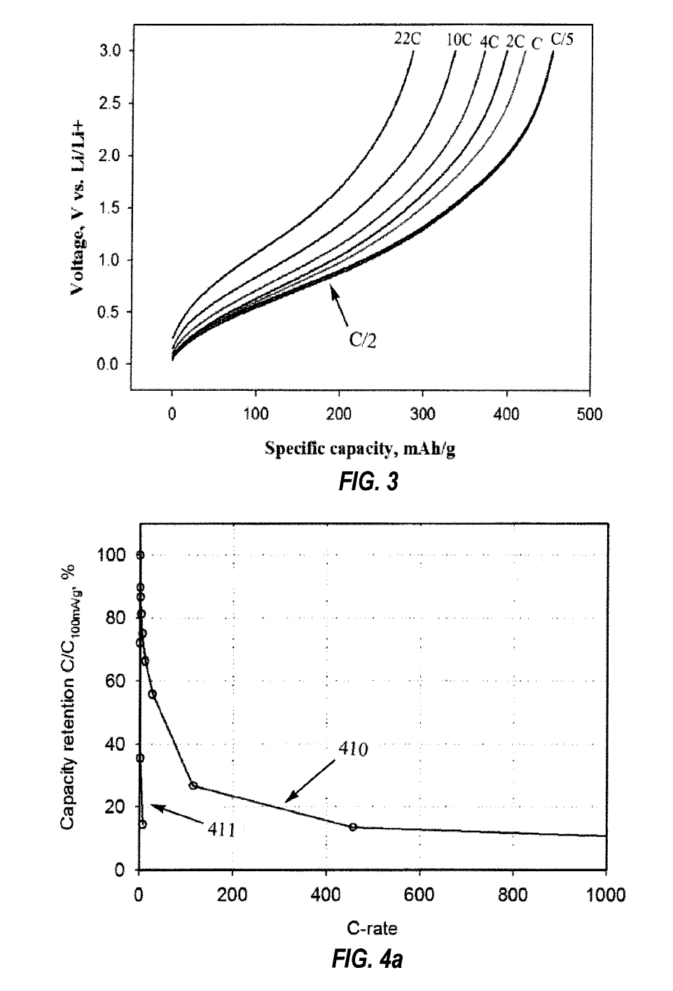

FIG. 3 shows the measured discharge rate capability of the Powder-Anode of Example 4 after charging at 100 mA/g current density with 0.01V˜3.0V voltage-window as the C-rate was increased from 0.2 C (or C/5) to 22 C. FIG. 3 demonstrates the change in the capacity when the anode is discharged at higher and higher rates. In all these tests, the charging rate was kept constant at 100 mA/g, while the discharging rate was progressively increased. The discharge curves in FIG. 3 prove that there is approximately a 50% drop in the capacity, which is better than any other anode materials as reported in K. Lee et al., Adv. Funct. Mater. (2005).

### Example 7

### Capacity Retention

In this example, anodes constructed from carbonaceous material graphite and MCMB were used as a control for comparison.

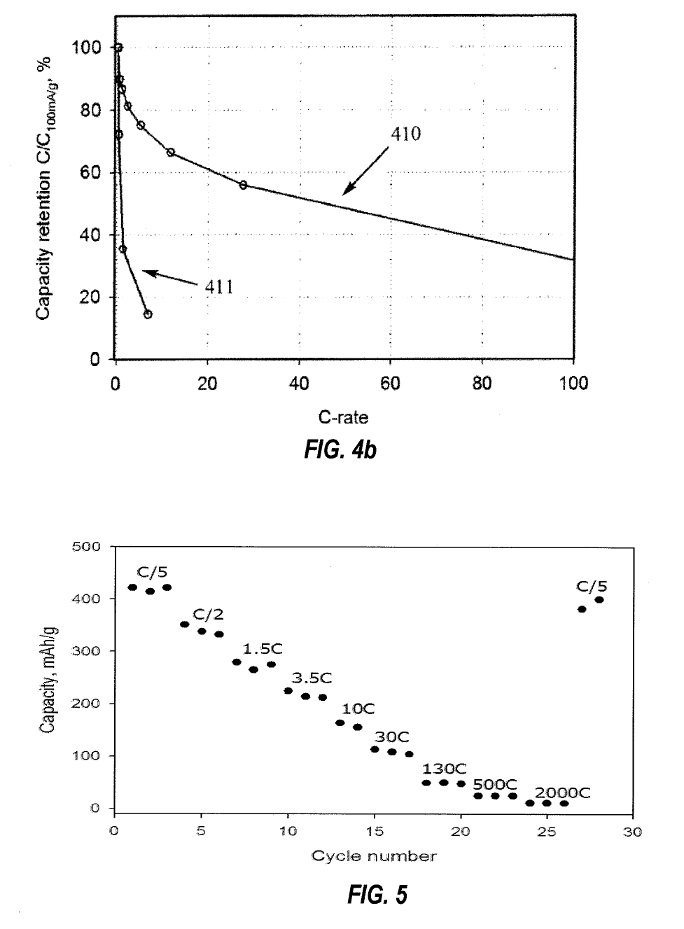

FIG. 4a shows the capacity retentions of the Powder-Anode from Example 4 as compared with the control under 0.01V ˜2.5V voltage-window as a function of C-rate in a range up to 1000 C. FIG. 4b is the magnified portion of FIG. 4a in the C-rate of 0-100 C.

Similar to FIG. 3, FIGS. 4a and 4b show the change in the capacity when the anode was discharged at higher and higher rates. In all these tests, the charging rate was kept constant at 100 mA/g, while the discharging rate was progressively increased. With reference to FIGS. 4a and 4b, curves 410 are the capacity retention of the Powder-Anode from Example 4 as a function of C-rate, and curves 411 are the capacity retention of the control anode as a function of C-rate.

As disclosed in L. Bazin et al., J. Power Sources, 188 (2009), the control in this example is known to have the state-of-the-art anode performance for Li-ion batteries. However, FIGS. 4a and 4b demonstrate that the control failed at rates greater than about 10 C, but the anode of Example 4 failed after a much higher rate. In other words, the C-rate results for Powder-Anodes disclosed herein far exceed the state-of-the-art anode performance for Li-ion batteries of the prior art.

### Example 8

### Discharge Capacity

FIG. 5 shows the discharge capacities of the Powder-Anode from Example 4 under different current density states with 0.01V ˜2.5V voltage-window. Charge/discharge current was applied the same in each 3 cycles. The legend “C/n” in FIG. 5 denotes the rate at which a full charge or discharge takes n hours.

FIG. 5 demonstrates the high resistance of the Powder-Anodes to failure even when exposed to 2000 C in symmetrical cycles, that is, where the rate used for charging is equal to the rate used for discharging. Therefore, at 2000 C the anode was fully charged in 1.8 seconds, and discharged in 1.8 seconds. In this example, the capacity is smaller than the results for the asymmetrical cycles shown in FIGS. 4a and 4b. The most significant aspect of these results is that even when forced to charge/discharge at 2000 C, the anode recovers fully when the charge rate is restored to 0.2 C (or C/5). These data show that the anode is robust and does not fail even under the most severe loading conditions.

### Example 9

### Power Density

The product of the energy density, the average voltage and the C-rate provides a measure of the power density for the anode, according to the following equation:

Power Density=Q×C×V Eq. (1)

where,

Q is the specific capacity, Ah/g;

C is the C-rate (1/h); and

V is the operating voltage.

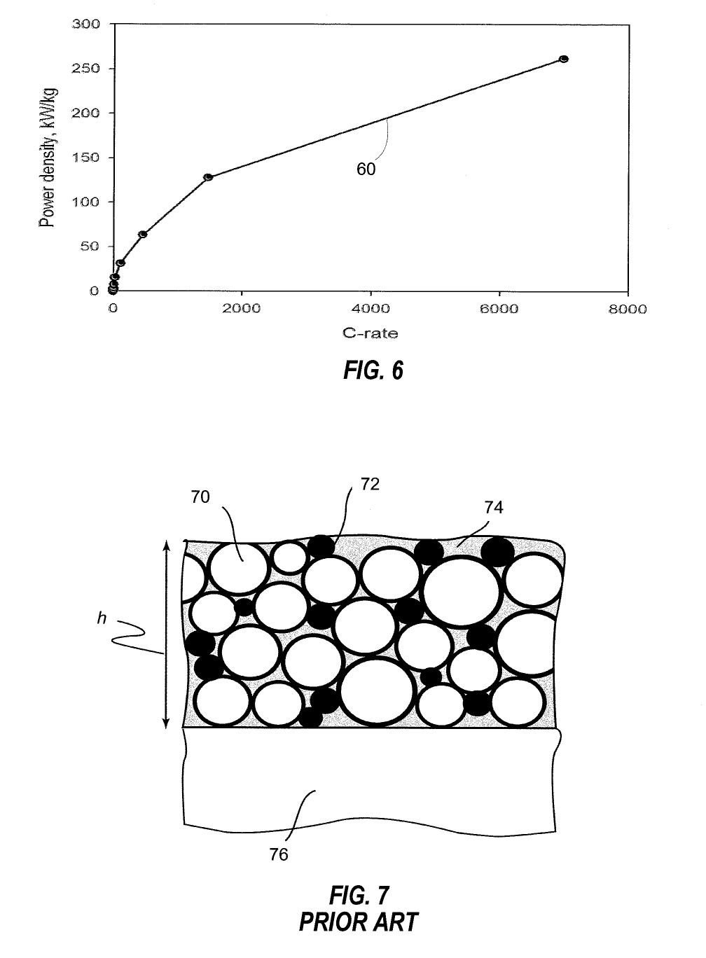

The data in FIGS. 4a, 4b, and 5, when inserted into Eq. (1), give the power density of the anode as a function of the C-rate, as shown in FIG. 6.

Curve 60 in FIG. 6 shows the power density of the Powder-Anode of Example 4 as a function of C-rate with a 0.01-2.5V voltage-window. The results in FIG. 6 demonstrate that up to 250 kW/kg power density is achieved. This value is 100 to 1000 times greater than the power density disclosed in the prior art.

### Example 10

### Architecture and Preparation of Powder-Anodes

Powder-Anodes (FIG. 7) are prepared by mixing graphene oxide with an organic polymer such as polysiloxanes and polysilazanes, followed by crosslinking the polymer in the 200° C. to 500° C. range, pulverizing the crosslinked, epoxy-like polymer into a powder, followed by pyrolysis in the 700° C. to 1200° C. range. This anode powder 70 is mixed with a conducting agent 72 and a binder 74, and the slurry is coated onto the metallic current collector 76, yielding the final anode architecture.

### Example 11

### Preparation of Anodes with Cast-Film-Anode Architecture

A “one-pot” process is used to prepare monolithic anodes according to exemplary embodiments. A mixture of graphene oxide and liquid polymer is directly cast onto a current collector, then crosslinked and pyrolyzed in place to bond the anode constituents to the surface of the current collector.

A liquid spray method, adapted from the process described in U.S. Pat. No. 5,451,260 is used to create Cast-Film-Anode architectures. The process described in the '260 Patent described methods for creating films having thickness of 0.1 to 10 micrometers. A continuous multilayer process, employing several cycles of spraying, crosslinking, and pyrolyzing, is used to manufacture monolithic anodes having thicknesses between 1 micrometer and 1000 micrometers, or between 25 micrometers and 400 micrometers, or between 50 micrometers and 300 micrometers, or between 100 micrometers and 250 micrometers.

A dip-coating method is also used to create Cast-Film-Anode architectures. In the dip-coating method, the current collector is physically dipped into a liquid mixture of graphene oxide and organic polymer. Upon removal of the current collector from the liquid mixture, a thin film of the mixture remains on the surface. This film is crosslinked and pyrolyzed as described above. The dipping, crosslinking, pyrolyzing cycle is repeated multiple times to achieve a desired anode thickness, h*.

A direct casting method is also used to create Cast-Film-Anode architectures. A film of the liquid precursor is case onto the surface of the current collector, with the thickness of the coating corresponding to the final thickness of the Cast-Film-Anode, allowing for shrinkage that occurs during pyrolysis. The liquid precursor is modified by the addition of catalysts using well-established methods so that it can be crosslinked with UV radiation. See “Ceramic MEMS—New Materials, Innovative Processing and Future Applications”, L. Liew, W. Zhang, Linan An, S. Shah, R. Lou, Y. Liu, T. Cross, K. Anseth, V. Bright, J. W. Daily and R. Raj, Am. Cer. Soc. Bull., Vol 80(5), 25-30 (May 2001); “Fabrication of SiCN MEMS by photopolymerization of pre-ceramic polymer?”, Liew L A, Liu Y P, Luo R L, Cross T, An L N, Bright V M, Dunn M L, Daily J W, R. Raj, Sensors and Actuators A-Phys, Vol. 95(2-3), 120-134 (2002); “Polymer-derived ceramic materials from thiol-ene photopolymerizations”, Reddy S K, Cramer N B, Cross T, Raj R, Bowman C N, Chemistry of Materials, Vol. 15 (22) 4257-4261 (2003).

Changes may be made in the above compositions, methods, and systems without departing from the scope hereof. It should be noted that the matter contained in the above description or shown in the accompanying drawings should be interpreted as illustrative and not in a limiting sense. The following claims are intended to cover all generic and specific features described herein, as well as all statements of the scope of the present compositions, methods and systems and reasonable variations thereof, which, as a matter of language, might be said to fall there between.

What is claimed is:

1. An electrode comprising a current collector and a cast-film-anode disposed over at least a portion of the current collector.

2. The electrode of claim 1, further comprising a bond coat interposed between the current collector and the cast film anode.

3. The electrode of claim 1, further comprising a conducting agent and an electrolyte to four at least one channel.

4. The electrode of claim 3, wherein the at least one channel is uniform.

5. The electrode of claim 3, wherein the at least one channel is non-uniform.

6. The electrode of claim 3, wherein the conducting agent comprises a material selected from the group consisting of acetylene black and graphene flakes.

7. The electrode of claim 3, wherein the electrolyte comprises a lithium salt.

8. The electrode of claim 7, wherein the lithium salt comprises at least one material selected from the group consisting of LiPF₆, LiBF₄, and LiClO₄.

9. The electrode of claim 3, wherein the electrolyte is a polymer-based electrolyte.

10. The electrode of claim 3, wherein the electrolyte is a solid-state electrolyte.

11. The electrode of claim 1, wherein the current collector is fabricated of a metal foil that does not react with lithium.

12. The electrode of claim 1, wherein the Cast-Film-Anode is made of a material comprising a nanocomposite and a silicon-based polymer.

13. The electrode of claim 12, wherein the nanocomposite comprises at least one material selected from the group consisting of graphene oxide and carbon nanotubes.

14. The electrode of claim 12, wherein the silicon-based polymer is a pyrolyzed silicon-based polymer.

15. The electrode of claim 14, wherein the pyrolyzed silicon-based polymer is made of a material comprising at least three elements selected from the group consisting of oxygen, nitrogen, carbon and hydrogen.

16. The electrode of claim 1, wherein the Cast-Film-Anode is made of a material comprising grapheme oxide and a silicon-based polymer.

17. The electrode of claim 1, wherein the electrode has an energy density for lithium ranging from 1 mAhcm⁻² to 100 mAhcm⁻².

18. A lithium-ion battery including the electrode of claim 1.

19. A method of preparing a Cast-Film-Anode electrode comprising: (i) providing a current collector; (ii) masking the current collector; (iii) applying an anode material comprising a graphene oxide and a liquid polymer to at least a portion of a surface of the current collector, (iii) crosslinking the anode material; (iv) pyrolyzing the crosslinked anode material in an inert atmosphere at temperatures of up to 1100° C.; (v) removing the mask to reveal channels; and (vi) applying a conducting agent and an electrolyte to the channels.

20. The method of claim 19, wherein the anode material has a thickness ranging from 1 μm to 1000 μm.

21. The method of claim 19, wherein the step of applying comprises a process selected from the group consisting of a liquid spray process, a dip-coating process, and a direct casting process.

22. A method of preparing a Cast-Film-Anode electrode comprising: (i) providing a current collector; (ii) applying an anode material comprising a graphene oxide and a liquid polymer to at least a portion of a surface of the current collector; (iii) pyrolyzing the anode material in an inert atmosphere at temperatures of up to 1100° C. to affect spontaneous cracking; and (iv) applying a conducting agent and an electrolyte to the cracked anode material.

23. The method of claim 22, wherein the anode material has a thickness ranging from 1 μM to 1000 μm.

24. The method of claim 22, wherein the step of applying comprises a process selected from the group consisting of a liquid spray process, a dip-coating process, and a direct casting process.
